(19) United States
(12) Patent Application Publication
(10) Pub. No.: US 2022/0383452 A1
(43) Pub. Date: Dec. 1, 2022

(54) METHOD, APPARATUS, ELECTRONIC DEVICE AND MEDIUM FOR IMAGE SUPER-RESOLUTION AND MODEL TRAINING

(71) Applicant: Beijing Kingsoft Cloud Network Technology Co., Ltd., Beijing (CN)

(72) Inventors: Fangbo LU, Beijing (CN); Xian WANG, Beijing (CN); Hongfei FAN, Beijing (CN); Yuan CAI, Beijing (CN)

(21) Appl. No.: 17/772,306

(22) PCT Filed: Dec. 9, 2020
(86) PCT No.: PCT/CN2020/135037

§ 371 Date: Apr. 27, 2022

(30) Foreign Application Priority Data
Dec. 20, 2019 (CN) 201911329508.5
Dec. 20, 2019 (CN) CN201911329473.5

(51) Int. Cl. G06T 3/40; G06V 10/80; G06N 3/04

(52) U.S. Cl. CPC G06T 3/4053; G06V 10/80; G06N 3/0472

(57) ABSTRACT

The embodiments of the present application provide method, apparatus, electronic device, and medium for image super-resolution and model training. The method includes: inputting the image to be processed into a first super-resolution network model and a second super-resolution network model trained in advance, respectively; the first super-resolution network model is a trained convolutional neural network; the second super-resolution network model is a generative network included in a trained generative adversarial network; obtaining a first image output from the first super-resolution network model and a second image output from the second super-resolution network model; fusing the first image and the second image to obtain a target image, wherein the resolution of the target image is greater than the resolution of the image to be processed.

### TECHNICAL FIELD

The present application claims the priority of a Chinese patent application NO. 201911329473.5 filed with the China National Intellectual Property Administration on Dec. 20, 2019 and entitled “method, apparatus, electronic device and storage medium for image super-resolution”, and the priority of a Chinese patent application NO. 201911329508.5 filed with the China National Intellectual Property Administration on Dec. 20, 2019 and entitled “method, apparatus, electronic device and medium for image super-resolution and model training”, which are incorporated herein by reference in their entireties.

### TECHNICAL FIELD

The present application relates to the technical field of image processing, and in particular, to a method, an apparatus, an electronic device, and a medium for image super-resolution and model training.

### BACKGROUND

At present, due to the environmental impacts, cost control and the like, image acquisition devices may acquire a plurality of low-resolution images with a low definition, which leads to poor user's visual experience. In order to improve the definition of an image, a method for image super-resolution is used to process an image to be processed with a lower resolution to obtain a target image with a resolution greater than that of the image to be processed.

In the related art, the method for image super-resolution is mainly to perform interpolation processing on an image to be processed to obtain a target image with a resolution greater than that of the image to be processed, e.g., to process the image to be processed using methods such as nearest neighbor interpolation, linear interpolation, cubic spline interpolation and the like to obtain a target image with a resolution greater than that of the image to be processed. However, with the above method for image super-resolution, the definition of the obtained target image still needs to be improved.

### SUMMARY

The purpose of the embodiments of the present application is to provide a method, an apparatus, an electronic device, and a medium for image super-resolution and model training to obtain a target image with a higher definition. The specific technical solutions are as follows:

In a first aspect, an embodiment of the present application provides a method for image super-resolution, the method includes: obtaining an image to be processed; inputting the image to be processed into a first super-resolution network model and a second super-resolution network model trained in advance, respectively; wherein the first super-resolution network model is a convolutional neural network trained using a plurality of original sample images and corresponding target sample images; the second super-resolution network model is a generative network included in a generative adversarial network trained using a plurality of original sample images and corresponding target sample images; the network structures of the first super-resolution network model and the second super-resolution network model are the same; the resolutions of the target sample images are greater than the resolutions of the original sample images; obtaining a first image output from the first super-resolution network model and a second image output from the second super-resolution network model; wherein the resolution of the first image and the resolution of the second image are both greater than the resolution of the image to be processed; and fusing the first image and the second image to obtain a target image, wherein the resolution of the target image is greater than the resolution of the image to be processed.

In a second aspect, an embodiment of the present application provides a method for image super-resolution, the method includes: obtaining an image to be processed; inputting the image to be processed into a pre-trained super-resolution reconstruction model; wherein the super-resolution reconstruction model is obtained by training a preset convolutional neural network and a generative adversarial network comprising a generative network and a discrimination network respectively using a plurality of training samples and then performing parameter fusion on network parameters of the trained preset convolutional neural network and network parameters of the trained generative network; the network structures of the super-resolution reconstruction model, the preset convolutional neural network and the generative network are the same; wherein each training sample comprises an original sample image and a corresponding target sample image, the resolution of the target sample image is greater than the resolution of the original sample image; and obtaining a target image corresponding to the image to be processed output from the super-resolution reconstruction model, wherein the resolution of the target image is greater than the resolution of the image to be processed.

In a third aspect, an embodiment of the present application provides a method for training a super-resolution reconstruction model, the method includes: obtaining a training sample set containing a plurality of training samples; wherein each training sample comprises an original sample image and a corresponding target sample image; the resolution of the target sample image is greater than the resolution of the original sample image; training a preset convolutional neural network based on the training sample set and taking the trained preset convolutional neural network as a target convolutional neural network model; training a generative adversarial network based on the training sample set and taking a generative network in the trained generative adversarial network as a target generative network model; performing weighted fusion on the network parameters of each layer of the target convolutional neural network model and the network parameters of each layer of the target generative network model respectively to obtain fused network parameters; creating a super-resolution reconstruction model; wherein the network structure of the super-resolution reconstruction model is the same as the network structures of the preset convolutional neural network and the generative network, and the network parameters of the super-resolution reconstruction model are the fused network parameters.

In a fourth aspect, an embodiment of the present application provides an apparatus for image super-resolution, the apparatus includes: a to-be-processed image obtaining unit configured for obtaining an image to be processed; an input unit configured for inputting the image to be processed into a first super-resolution network model and a second super-resolution network model trained in advance, respectively; wherein the first super-resolution network model is a convolutional neural network trained using a plurality of original sample images and corresponding target sample images; the second super-resolution network model is a generative network contained in a generative adversarial network trained using a plurality of original sample images and corresponding target sample images; the network structures of the first super-resolution network model and the second super-resolution network model are the same; the resolutions of the target sample images are greater than the resolutions of the original sample images; an obtaining unit configured for obtaining a first image output from the first super-resolution network model and a second image output from the second super-resolution network model; wherein the resolution of the first image and the resolution of the second image are both greater than the resolution of the image to be processed; a target image obtaining unit configured for fusing the first image and the second image to obtain a target image, wherein the resolution of the target image is greater than the resolution of the image to be processed.

In a fifth aspect, an embodiment of the present application provides apparatus for image super-resolution, the apparatus includes: a to-be-processed image obtaining unit configured for obtaining an image to be processed; a to-be-processed image inputting unit configured for inputting the image to be processed into a pre-trained super-resolution reconstruction model; wherein the super-resolution reconstruction model is obtained by training a preset convolutional neural network and a generative adversarial network comprising a generative network and a discrimination network respectively using a plurality of training samples and then performing parameter fusion on network parameters of the trained preset convolutional neural network and network parameters of the trained generative network; the network structures of the super-resolution reconstruction model, the preset convolutional neural network and the generative network are the same; wherein, each training sample comprises an original sample image and a corresponding target sample image, the resolution of the target sample image is greater than the resolution of the original sample image. a target image obtaining unit configured for obtaining a target image corresponding to the image to be processed output from the super-resolution reconstruction model, wherein the resolution of the target image is greater than the resolution of the image to be processed.

In a sixth aspect, an embodiment of the present application provides an apparatus for training the super-resolution reconstruction model, the apparatus includes: a sample set obtaining unit configured for obtaining a training sample set containing a plurality of training samples; wherein each training sample comprises an original sample image and a corresponding target sample image; the resolution of the target sample image is greater than the resolution of the original sample image; a target convolutional neural network model obtaining unit configured for training a preset convolutional neural network based on the training sample set and taking the trained preset convolutional neural network as a target convolutional neural network model; a target generative network model obtaining unit configured for training a generative adversarial network based on the training sample set and taking a generative network in the trained generative adversarial network as a target generative network model; a fusion unit configured for performing weighted fusion on network parameters of each layer of the target convolutional neural network model and network parameters of each layer of the target generative network model respectively to obtain fused network parameters; a super-resolution reconstruction model creation unit configured for creating a super-resolution reconstruction model; wherein the network structure of the super-resolution reconstruction model is the same as the network structures of the preset convolutional neural network and the generative network, and the network parameters of the super-resolution reconstruction model are the fused network parameters.

In a seventh aspect, an embodiment of the present application provides an electronic device, including a processor, a communication interface, a memory, and a communication bus, wherein the processor, the communication interface, and the memory are communicated with each other through the communication bus; the memory is configured to store a computer program; the processor is configured to implement the method for image super-resolution provided in the first or second aspect, or the method for training a super-resolution reconstruction model provided in the third aspect.

In a eighth aspect, an embodiment of the present application provides a computer-readable storage medium storing a computer program thereon, wherein the computer program implements the method for image super-resolution provided in the first or second aspect, or the method for training a super-resolution reconstruction model provided in the third aspect when executed by a processor.

In a ninth aspect, an embodiment of the present application also provide a computer program product comprising instructions, which when executed by a computer, cause the computer to perform the method for image super-resolution provided in the first or second aspect, or the method for training a super-resolution reconstruction model provided in the third aspect.

In the solution provided by the embodiments of the present application, the image to be processed can be obtained; the image to be processed is respectively input to a first super-resolution network model and a second super-resolution network model trained in advance; wherein the first super-resolution network model is a convolutional neural network trained using a plurality of original sample images and corresponding target sample images; the second super-resolution network model is a generative network contained in a generative adversarial network trained using a plurality of original sample images and corresponding target sample images; the network structures of the first super-resolution network model and the second super-resolution network model are the same; the resolutions of the target sample images are greater than the resolutions of the original sample images; a first image output from the first super-resolution network model and a second image output from the second super-resolution network model are obtained, the resolution of the first image and the resolution of the second image are both greater than the resolution of the image to be processed; the first image and the second image are fused to obtain a target image, wherein the resolution of the target image is greater than the resolution of the image to be processed. It can be seen that by applying the embodiments of the present application, the first image output from the first super-resolution network model and the second image output from the second super-resolution network model can be fused to obtain a target image. The target image takes into account the advantages of the first image output from the first super-resolution network model and the second image output from the second super-resolution network model, and thus has a higher definition. Of course, it is not necessary for any product or method implementing the present application to achieve all of the above advantages at the same time.

### BRIEF DESCRIPTION OF THE DRAWINGS

In order to more clearly illustrate the technical solutions of the embodiments of the present application and related art, the drawings used in the embodiments and related art are described briefly below. Obviously, the drawings in the following description are only some embodiments of the present application, and other drawings can be obtained by those skilled in the art based on these drawings without creative efforts.

FIG. 1 is a schematic flowchart of a method for image super-resolution according to an embodiment of the present application;

FIG. 2 is a schematic flowchart of a method for training a first super-resolution reconstruction model according to an embodiment of the present application;

FIG. 3 is a schematic flowchart of a method for training a second super-resolution reconstruction model according to an embodiment of the present application;

FIG. 4 is a schematic flowchart of a method for image super-resolution according to another embodiment of the present application;

FIG. 5 is a schematic flowchart of a method for training a super-resolution reconstruction model according to an embodiment of the present application;

FIG. 6 is a schematic flowchart of a method for training a super-resolution reconstruction model according to another embodiment of the present application;

FIG. 7 is a schematic structural diagram of an apparatus for image super-resolution according to an embodiment of the present application;

FIG. 8 is a schematic structural diagram of an apparatus for image super-resolution according to another embodiment of the present application;

FIG. 9 is a schematic structural diagram of an apparatus for training a super-resolution reconstruction model according to an embodiment of the present application;

FIG. 10 is a schematic structural diagram of an electronic device according to an embodiment of the present application.

### DETAILED DESCRIPTION

In order to make the purpose, technical solutions, and advantages of the present application clearer, the present application will be described below in detail with reference to the accompanying drawings and embodiments. Obviously, the described embodiments are only a part of the embodiments of the present application, rather than all the embodiments. Based on the embodiments in the present application, all other embodiments obtained by those skilled in the art without creative efforts fall within the protection scope of the present application.

The method for image super-resolution and the method for training a super-resolution reconstruction model provided by the embodiments of the present application can be applied to any electronic device that needs to process low-resolution images to obtain higher-resolution images, such as a computer, a mobile device, etc., which is not specifically limited herein. For the convenience of description, it is referred to an electronic device hereinafter.

In the embodiments of the present application, a method for image super-resolution based on neural network is used to process an image to be processed with a network model so as to obtain a target image with a higher definition by means of fusion. There are two ways of fusion: one is to fuse the images output from the two network models; the other is to fuse the network parameters of the two networks in a network model.

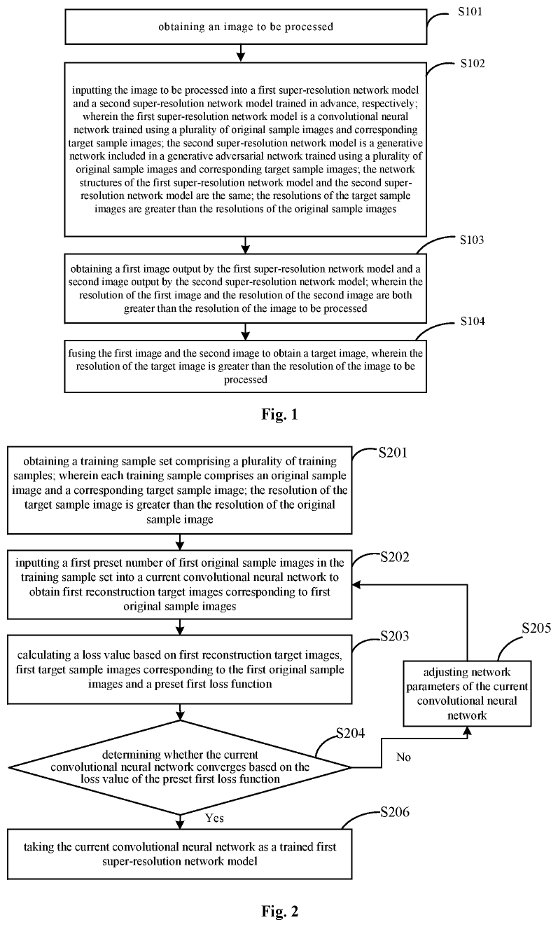

Referring to FIG. 1, which is a schematic flowchart of a method for image super-resolution according to an embodiment of the present application. As shown in FIG. 1, the specific processing flow of the method may include:

Step S101: obtaining an image to be processed.

Step S102: inputting the image to be processed into a first super-resolution network model and a second super-resolution network model trained in advance, respectively; wherein the first super-resolution network model is a convolutional neural network trained using a plurality of original sample images and corresponding target sample images; the second super-resolution network model is a generative network included in a generative adversarial network trained using a plurality of original sample images and corresponding target sample images; the network structures of the first super-resolution network model and the second super-resolution network model are the same; the resolutions of the target sample images are greater than the resolutions of the original sample images.

Step S103: obtaining a first image output from the first super-resolution network model and a second image output from the second super-resolution network model; wherein the resolution of the first image and the resolution of the second image are both greater than the resolution of the image to be processed.

Step S104: fusing the first image and the second image to obtain a target image, wherein the resolution of the target image is greater than the resolution of the image to be processed.

The method according to the embodiment of the present application can be used to fuse the first image output from the first super-resolution network model and the second image output from the second super-resolution network model so as to obtain a target image. The target image takes into account the advantages of the first image output from the first super-resolution network model and the second image output from the second super-resolution network model, and thus has a higher definition.

In an embodiment, the above Step S104 may be: fusing pixel values of the pixels in the first image and pixel values of the pixels in the second image according to weights to obtain a target image; wherein the weights are preset or determined based on the resolution of the first image and the resolution of the second image. The target image can be obtained through the following two implementations.

In the first implementation, weighted fusion can be performed on the pixel values of the pixels in the first image and the pixel values of the pixels in the second image according to preset weights to obtain the target image. The pixel values of the pixels in the first image and the pixel values of the pixels in the second image can be fused according to the weights based on equation (1) to obtain the fused image as the target image:

img3=alpha1*img1+(1−alpha1)*img2 (1)

where, alpha1 is the weight of a pixel value for each pixel in the first image respectively, img1 is the pixel value for each pixel in the first image respectively, img2 is the pixel value for each pixel in the second image respectively, and img3 is the pixel value for each pixel in the target image respectively; and the value range of alpha1 is [0,1].

In the second implementation, the weight can be determined based on the resolution of the first image and the resolution of the second image. The pixel values of the pixels in the first image and the pixel values of the pixels in the second image are fused according to weight to obtain the target image. A larger weight value can be taken for the image with a larger resolution in the first image and the second image. For example, a target difference is calculated between the resolution of the first image and the resolution of the second image, and the weight is dynamically adjusted according to the target difference and the preset rule of taking a larger weight value for an image with a larger resolution.

In a more specific example, when the target difference is greater than a first preset threshold, a first weight can be taken for the pixel value of the first image, and a second weight can be taken for the pixel value of the second image. When the target difference is not greater than the first preset threshold, a third weight can be taken for the pixel value of the first image, and a fourth weight can be taken for the pixel value of the second image.

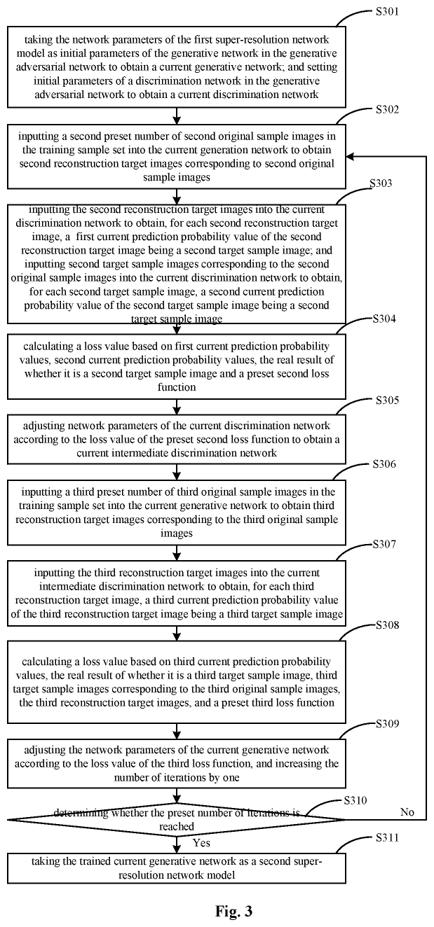

In an embodiment, references can be made to FIG. 2 for a specific training process of a first super-resolution reconstruction model in the above embodiments, and references can be made to FIG. 3 for a specific training process of a second super-resolution reconstruction model in the above embodiments. FIG. 2 is a schematic flowchart of a method for training a first super-resolution reconstruction model according to an embodiment of the present application. As shown in FIG. 2, the specific processing flow of the method may include:

Step S201: obtaining a training sample set containing a plurality of training samples, wherein each training sample comprises an original sample image and a corresponding target sample image; the resolution of the target sample image is greater than the resolution of the original sample image.

That is, the original sample image is a low-resolution sample image, and the target sample image is a high-resolution sample image. In an embodiment, the original sample image can be obtained from the target sample image by downsampling and the like, and the target sample image and the original sample image can be used as a training sample. The original sample image and the corresponding target sample image can also be obtained by shooting the same object at the same position with a low-definition camera and a high-definition camera, which is not specifically limited here.

Step S202: inputting a first preset number of first original sample images in the training sample set into a current convolutional neural network to obtain first reconstruction target images corresponding to the first original sample images.

In this step, the first original sample image can be referred to as a first low-resolution sample image. The resolution of the obtained first reconstruction target image is greater than that of the first original sample image. Therefore, the first reconstruction target image can be referred to as a first reconstruction high-resolution image. In an embodiment, a first preset number of first original sample images in the training sample set are input into a current Convolutional Neural Networks (CNN) to obtain a first reconstruction target image. In an embodiment, the first preset number may be 8, 16, 32, etc., and is not specifically limited here.

Step S203: calculating a loss value based on the first reconstruction target images, first target sample images corresponding to the first original sample images and a preset first loss function.

In this step, the first target sample image may also be referred to as a first high-resolution sample image.

In an embodiment, the first loss function may be:

$$L 1 = \frac{I}{{h}_{1} {w}_{1} {c}_{1}} {\sum }_{i , j , k} \vert {I}_{i , j , k}^{1 HR} - {I}_{i , j , k}^{1 HR} \vert \qquad ( 2 )$$

where L1 is the loss value of the first loss function; I_{i,j,k}^{1HR′} is the pixel value of the pixel with row number i and column number j of the k-th channel of the first reconstruction target image I^{1HR′} (that is, the first reconstruction high-resolution image). For example, a first reconstruction high-resolution image I^{1HR′} is represented by an RGB color space model, and the pixel size is 128*128. The first reconstruction high-resolution image I^{1HR′} has three channels, the value of k is 1 for the first channel, and it contains 128 rows and 128 columns. The pixel value of the pixel in the first row and first column of the first channel of the first reconstruction high-resolution image I^{1HR′} can be represented as I_{1,1,1}^{1HR′}. I_{i,j,k}^{1HR} is the pixel value of the pixel with row number i and column number j of the k-th channel of the first target sample image I^{1HR} (that is, the first high-resolution sample image); h₁, w₁ and c₁ are the height, the width and the number of channels of the first reconstruction high-resolution image respectively; h₁w₁c₁ is the product of the height, the width and the number of channels of the first reconstruction high-resolution image.

In other embodiments, other loss functions can be used, for example, equation (2), a mean square deviation loss function in the related art, and the like. The specific equation of the first loss function is not limited herein.

Step S204: determining whether the current convolutional neural network converges based on the loss value of the preset first loss function.

If the result of the determination is NO, that is, the current convolutional neural network does not converge, then Step S205 is performed; if the result of the determination is YES, that is, the current convolutional neural network converges, then Step S206 is performed. Whether the convolutional neural network converges in the present application specifically means whether the loss of the convolutional neural network converges.

Step S205: adjusting network parameters of the current convolutional neural network, and returning to Step S202.

Step S206: taking the current convolutional neural network as a trained first super-resolution network model.

The convolutional neural network is trained to obtain a first super-resolution network model, a first image output from the first super-resolution network model is relatively stable, in which generally no artifacts appear.

In an embodiment, after obtaining the trained first super-resolution network model, a Generative Adversarial Network (GAN) may be trained, and the generative network in the trained generative adversarial network may be used as the second super-resolution network model. Specifically, the training process of the second super-resolution network model can be seen in FIG. 3. As shown in FIG. 3, a schematic flowchart of a method for training a second super-resolution network model according to an embodiment of the present application may include:

Step S301: taking the network parameters of the first super-resolution network model as initial parameters of the generative network in the generative adversarial network to obtain a current generative network; and setting initial parameters of a discrimination network in the generative adversarial network to obtain a current discrimination network. In an embodiment, the discrimination network in the generative adversarial network may be a convolutional neural network or other networks. The network structure of the discrimination network is not specifically limited here. The network structures of the preset convolutional neural network, the generative network and the discrimination network are not specifically limited, and can be set according to actual needs.

Step S302: inputting a second preset number of second original sample images in the training sample set into the current generative network to obtain second reconstruction target images corresponding to the second original sample images. In this step, the second original sample image can be referred to as a second low-resolution sample image. The resolution of the second reconstruction target image is greater than the resolution of the second original sample image, and thus, the second reconstruction target image can be referred to as a second reconstruction high-resolution image.

In an embodiment, the second preset number may be 8, 16, 32, etc., and is not specifically limited here.

Step S303: inputting the second reconstruction target images into the current discrimination network to obtain, for each second reconstruction target image, a first current prediction probability value of the second reconstruction target image being a second target sample image; and inputting second target sample images corresponding to the second original sample images into the current discrimination network to obtain, for each second target sample image, a second current prediction probability value of the second target sample image being a second target sample image. In this step, the second target sample image can be referred to as a second high-resolution sample image.

Step S304: calculating a loss value based on first current prediction probability values, second current prediction probability values, the real result of whether it is a second target sample image and a preset second loss function. In an embodiment, the preset second loss function may specifically be:

Dₗₒₛₛ=Σ[log D(I^{2HR})]+Σ[1−log D(G(I^{2HR}))] (3)

where D is the discrimination network; Dₗₒₛₛ is the loss value of the discrimination network, i.e., the loss value of the second loss function; I^{2HR} is the second target sample image, i.e., the second high-resolution sample image; D(I^{2HR}) is the second current prediction probability value obtained after the second high-resolution sample image is input into the current discrimination network; I^{2LR} is the second original sample image, i.e., the second low-resolution sample image; G(I^{2LR}) is the second reconstruction high-resolution image obtained after the second low-resolution sample image is input into the current generative network; D(G(I^{2LR})) is the first current prediction probability value obtained by inputting the second reconstruction high-resolution image into the current discrimination network.

Step S305: adjusting network parameters of the current discrimination network according to the loss value of the preset second loss function to obtain a current intermediate discrimination network.

Step S306: inputting a third preset number of third original sample images in the training sample set into the current generative network to obtain third reconstruction target images corresponding to the third original sample images. In this step, the third original sample image can be referred to as a third low-resolution sample image. The resolution of the third reconstruction target image is greater than that of the third original sample image, and thus the third reconstruction target image can be referred to as a third reconstruction high-resolution image. In an embodiment, the third preset number may be 8, 16, 32, etc., and is not specifically limited here. In an embodiment, the first preset number, the second preset number, and the third preset number may be the same or different, which are not specifically limited here.

Step S307: inputting the third reconstruction target images into the current intermediate discrimination network to obtain, for each third reconstruction target image, a third current prediction probability value of the third reconstruction target image being a third target sample image. In this step, the third target sample image can be referred to as a third high-resolution sample image.

Step S308: calculating a loss value based on third current prediction probability values, the real result of whether it is a third target sample image, third target sample images corresponding to the third original sample images, the third reconstruction target images, and a preset third loss function. In an embodiment, the preset third loss function may specifically be:

Loss=α*L1′+β*l_{VGG}^{SR}+γ*l_{Gen}^{SR} (4)

where L1′, l_{VGG}^{SR} and l_{Gen}^{SR} are the loss values calculated based on the following equation respectively; α, β and γ are the weight coefficients of L1′, l_{VGG}^{SR} and l_{Gen}^{SR} respectively.

$$L {1}^{′} = \frac{1}{{h}_{2} {w}_{2} {c}_{2}} {\sum }_{i , j , k} \vert {I}_{i , j , k}^{3 HR} - {I}_{i , j , k}^{3 HR} \vert \qquad ( 5 )$$

where I_{i,j,k}^{3HR′} is the pixel value of the pixel with row number i and column number j of the k-th channel of the third reconstruction target image I^{3HR′} (that is, the third reconstruction high-resolution image). I_{i,j,k}^{3HR} is the pixel value of the pixel with row number i and column number j of the k-th channel of the third target sample image I^{3HR} (that is, the third high-resolution sample image); h₂, w₂ and c₂ are the height, the width and the number of channels of the third reconstruction high-resolution image, respectively; h₂w₂c₂ is the product of the height, the width and the number of channels of the third reconstruction high-resolution image.

$${1}_{VGG}^{SR} = \frac{1}{{W}_{i . j} {H}_{i , j}} {\sum }_{y = 1}^{{W}_{i , j}} {\sum }_{y = 1}^{{H}_{i , j}} {( {{ϕ}_{i , j} ( {I}^{3 HR} )}_{x , y} - {{ϕ}_{i , j} ( G ( {I}^{3 LR} ) )}_{x , y} )}^{2} \qquad ( 6 )$$

where l_{VGG}^{SR} is the loss value of l_{VGG}^{SR} loss function in the third loss function; W is the width of a filter; H is the height of the filter; i is the number of layers where the filter is located in the VGG network model pre-trained in related art; j indicates that the filter is located at the j-th of this layer in the VGG network model; W_{i,j} is the width of the j-th filter in the i-th layer of the VGG network model; H_{i,j} is the height of the j-th filter in the i-th layer of the VGG network model; Ø_{i,j}(I^{3HR})_{x,y} is the eigenvalue of the j-th filter in the i-th layer of the VGG network model pre-trained in the related art at the corresponding position of the third high-resolution sample image I^{3HR} where the row number is “x” and the column number is “y”; Ø_{i,j}(G(I^{3LR}))_{x,y} is the eigenvalue of the j-th filter in the i-th layer of the VGG network model pre-trained in the related art at the corresponding position of the third reconstruction high-resolution sample image G(I^{3LR}) where the abscissa is “x” and the ordinate is “y”; I^{3LR} is the third original sample image, i.e., the third low-resolution sample image.

l_{Gen}^{SR}=Σₙ₌₁^{N}−log D(G(I^{3LR})) (7)

where l_{Gen}^{SR} is a loss value of l_{Gen}^{SR} loss function in the third loss function; I^{3LR} is the third original sample image, i.e., the third low-resolution sample image; and D(G(I^{3LR})) is a third current prediction probability value output after the current intermediate discrimination network discriminates the third reconstruction high-resolution image G(I^{3LR}), and N is the number of third target sample images in one loss value calculation process.

Step S309: adjusting the network parameters of the current generative network according to the loss value of the third loss function, and increasing the number of iterations by one.

Step S310: determining whether a preset number of iterations is reached. In an embodiment, the preset number of iterations may be 100, 200, 1000, etc., and is not specifically limited here. If the result of the determination is NO, that is, the preset number of iterations is not reached, the process returns to Step S302; if the result of the determination is YES, that is, the preset number of iterations is reached, Step S311 is performed.

Step S311: taking the trained current generative network as a second super-resolution network model. The generative adversarial network is trained to obtain the second super-resolution network model, and a second image output from the second super-resolution network model can generate more high-frequency information and has more image details. The advantage of the trained first super-resolution network model is that the generated image is relatively stable, but the disadvantage is that the image lacks some high-frequency information. The advantage of the trained second super-resolution network model is that the generated image contains more high-frequency information, but the disadvantage is that the image may have artifacts and is not stable enough. The first image output from the first super-resolution network model and the second image output from the second super-resolution network model are fused, and the fused target image can contain more high-frequency information and has more image details; and the image is stable, the artifact problem of the image is balanced, and the definition of the target image is high.

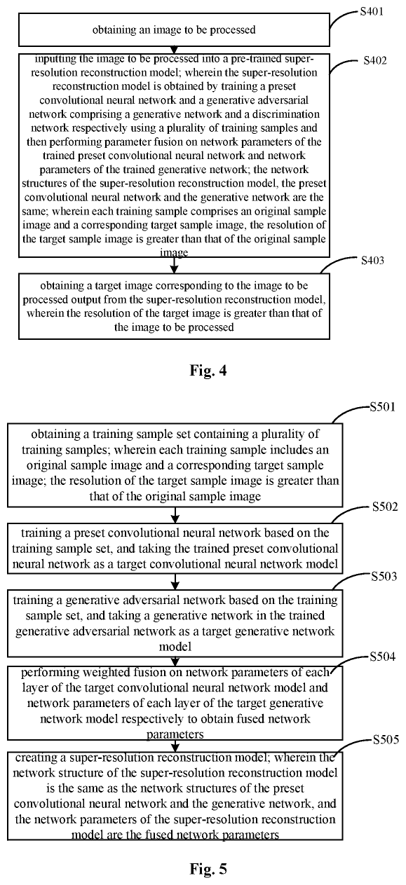

Referring to FIG. 4, a schematic flowchart of a method for image super-resolution according to another embodiment of the present application is shown. As shown in FIG. 4, the specific processing flow of the method may include:

Step S401: obtaining an image to be processed.

Step S402: inputting the image to be processed into a pre-trained super-resolution reconstruction model; wherein the super-resolution reconstruction model is obtained by training a preset convolutional neural network and a generative adversarial network comprising a generative network and a discrimination network respectively using a plurality of training samples and then performing parameter fusion on network parameters of the trained preset convolutional neural network and network parameters of the trained generative network; the network structures of the super-resolution reconstruction model, the preset convolutional neural network and the generative network are the same; wherein each training sample comprises an original sample image and a corresponding target sample image, the resolution of the target sample image is greater than that of the original sample image.

Step S403: obtaining a target image corresponding to the image to be processed output from the super-resolution reconstruction model, wherein the resolution of the target image is greater than that of the image to be processed.

It can be seen that by applying the method of the embodiments of the present application, the image to be processed can be input into the super-resolution reconstruction model to obtain a target image with a resolution greater than that of the image to be processed. The super-resolution reconstruction model is obtained by performing parameter fusion on the network parameters of the trained preset convolutional neural network and the network parameters of the generative network in the trained generative adversarial network. The super-resolution reconstruction model takes into account the advantages of the convolutional neural network and the generative network in the generative adversarial network, and the obtained target image has a higher definition.

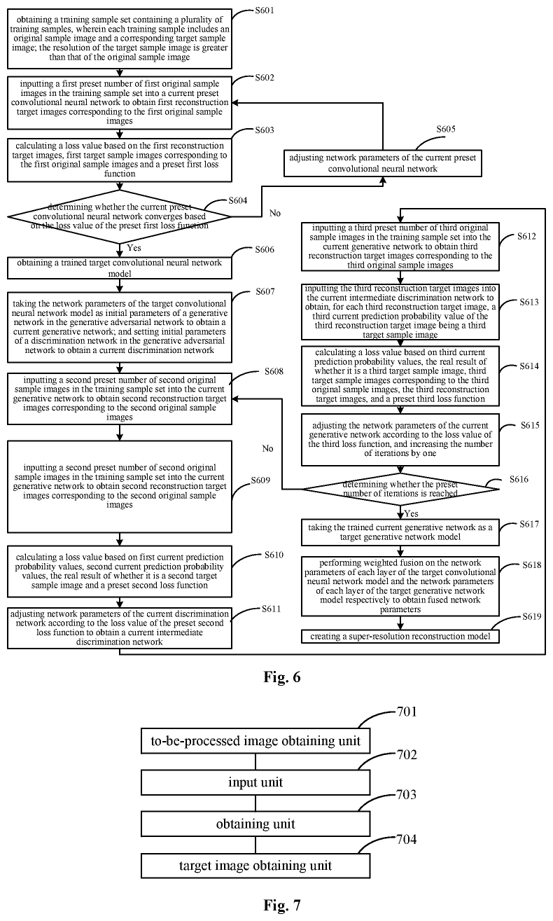

In an embodiment, the training process of the super-resolution reconstruction model in the above embodiments can be seen in FIGS. 5 and 6.

Referring to FIG. 5, a schematic flowchart of a method for training a super-resolution reconstruction model according to an embodiment of the present application is shown. As shown in FIG. 5, the specific processing flow of the method may include:

Step S501: obtaining a training sample set containing a plurality of training samples; wherein each training sample includes an original sample image and a corresponding target sample image; the resolution of the target sample image is greater than that of the original sample image.

Step S502: training a preset convolutional neural network based on the training sample set, and taking the trained preset convolutional neural network as a target convolutional neural network model.

Step S503: training a generative adversarial network based on the training sample set, and taking a generative network in the trained generative adversarial network as a target generative network model.

Step S504: performing weighted fusion on network parameters of each layer of the target convolutional neural network model and network parameters of each layer of the target generative network model respectively to obtain fused network parameters.

Step S505: creating a super-resolution reconstruction model; wherein the network structure of the super-resolution reconstruction model is the same as the network structures of the preset convolutional neural network and the generative network, and the network parameters of the super-resolution reconstruction model are the fused network parameters.

It can be seen that by applying the method of the embodiments of the present application, the image to be processed can be input into the super-resolution reconstruction model to obtain a target image with a resolution greater than that of the image to be processed. The super-resolution reconstruction model is obtained by performing parameter fusion on the network parameters of the trained preset convolutional neural network and the network parameters of the generative network in the trained generative adversarial network. The super-resolution reconstruction model takes into account the advantages of the convolutional neural network and the generative network in the generative adversarial network, and the obtained target image has a higher definition.

Referring to FIG. 6, a schematic flowchart of a method for training a super-resolution reconstruction model according to another embodiment of the present application is shown in FIG. 6, which may include:

Step S601: obtaining a training sample set containing a plurality of training samples, wherein each training sample includes an original sample image and a corresponding target sample image; the resolution of the target sample image is greater than that of the original sample image. That is, the original sample image is a low-resolution sample image, and the target sample image is a high-resolution sample image. In an embodiment, the original sample image may be obtained from the target sample image by downsampling and the like, and the target sample image and the original sample image may be used as a training sample. The original sample image and the corresponding target sample image can also be obtained by shooting the same object at the same position with a low-definition camera and a high-definition camera, which is not specifically limited here.

Step S602: inputting a first preset number of first original sample images in the training sample set into a current preset convolutional neural network to obtain first reconstruction target images corresponding to the first original sample images. In this step, the first original sample image can be referred to as a first low-resolution sample image. The resolution of the obtained first reconstruction target image is greater than that of the first original sample image. Therefore, the first reconstruction target image can be referred to as a first reconstruction high-resolution image. In an embodiment, a first preset number of first original sample images in the training sample set are input into a current preset convolutional neural network to obtain a first reconstruction target image. In an embodiment, the first preset number may be 8, 16, 32, etc., and is not specifically limited here.

Step S603: calculating a loss value based on the first reconstruction target images, first target sample images corresponding to the first original sample images and a preset first loss function. The first target sample image may also be referred to as a first high-resolution sample image. In an embodiment, the first loss function is specifically as shown in equation (2). In other embodiments, other loss functions may be used, for example, equation (2), a mean square deviation loss function in the related art, and the like. The specific equation of the first loss function is not limited herein.

Step S604: determining whether the current preset convolutional neural network converges based on the loss value of the preset first loss function; if the result of the determination is NO, that is, the current preset convolutional neural network does not converge, performing Step S605; if the result of the determination is YES, that is, the current preset convolutional neural network converges, performing Step S606.

Step S605: adjusting network parameters of the current preset convolutional neural network, and returning to Step S602.

Step S606: obtaining a trained target convolutional neural network model.

Step S607: taking the network parameters of the target convolutional neural network model as initial parameters of a generative network in the generative adversarial network to obtain a current generative network; and setting initial parameters of a discrimination network in the generative adversarial network to obtain a current discrimination network.

In an embodiment, the discrimination network in the generative adversarial network may be a convolutional neural network or another network. The discrimination network is not specifically limited here. The network structures of the preset convolutional neural network, the generative network and the discrimination network are not specifically limited, and can be set according to actual needs.

Step S608: inputting a second preset number of second original sample images in the training sample set into the current generative network to obtain second reconstruction target images corresponding to the second original sample images. In this step, the second original sample image can be referred to as a second low-resolution sample image. The resolution of the second reconstruction target image is greater than the resolution of the second original sample image, and thus, the second reconstruction target image can be referred to as a second reconstruction high-resolution image. In an embodiment, the second preset number may be 8, 16, 32, etc., and is not specifically limited here.

Step S609: inputting the second reconstruction target images into the current discrimination network to obtain, for each second reconstruction target image, a first current prediction probability value of the second reconstruction target image being a second target sample image; and inputting second target sample images corresponding to the second original sample images into the current discrimination network to obtain, for each second target sample image, a second current prediction probability value of the second target sample image being a second target sample image. In this step, the second target sample image can be referred to as a second high-resolution sample image.

Step S610: calculating a loss value based on first current prediction probability values, second current prediction probability values, the real result of whether it is a second target sample image and a preset second loss function. In an embodiment, the preset second loss function is specifically shown in equation (3).

Step S611: adjusting network parameters of the current discrimination network according to the loss value of the preset second loss function to obtain a current intermediate discrimination network.

Step S612: inputting a third preset number of third original sample images in the training sample set into the current generative network to obtain third reconstruction target images corresponding to the third original sample images. In this step, the third original sample image can be referred to as a third low-resolution sample image. The resolution of the third reconstruction target image is greater than that of the third original sample image, and thus the third reconstruction target image can be referred to as a third reconstruction high-resolution image. In an embodiment, the third preset number may be 8, 16, 32, etc., and is not specifically limited here. In an embodiment, the first preset number, the second preset number, and the third preset number may be the same or different, which are not limited specifically.

Step S613: inputting the third reconstruction target images into the current intermediate discrimination network to obtain, for each third reconstruction target image, a third current prediction probability value of the third reconstruction target image being a third target sample image. The third target sample image is also the third high-resolution sample image.

Step S614: calculating a loss value based on third current prediction probability values, the real result of whether it is a third target sample image, third target sample images corresponding to the third original sample images, the third reconstruction target images, and a preset third loss function. In an embodiment, the preset third loss function is specifically shown in equation (4).

Step S615: adjusting the network parameters of the current generative network according to the loss value of the third loss function, and increasing the number of iterations by one.

Step S616: determining whether a preset number of iterations is reached. In an embodiment, the preset number of iterations may be 100, 200, 1000, etc., and is not specifically limited here. If the result of the determination is YES, that is, the preset number of iterations is reached, then Step S617 is performed; if the result of the determination is NO, that is, the preset number of iterations is not reached, the process returns to Step S608.

Step S617: taking the trained current generative network as a target generative network model.

Step S618: performing weighted fusion on the network parameters of each layer of the target convolutional neural network model and the network parameters of each layer of the target generative network model respectively to obtain fused network parameters. In an embodiment, weighted fusion can be performed on the network parameters of each layer of the target convolutional neural network model and the network parameters of each layer of the target generative network model according to the following equation to obtain fused network parameters:

θ_{NET3}ⁿ=alpha1*θ_{NET1}ⁿ+(1−alpha1)*θ_{NET2}ⁿ (8)

where alpha1 is a weight coefficient of a network parameter of the target convolutional neural network model, θ_{NET1}ⁿ is a network parameter of the n-th layer of the target convolutional neural network model, θ_{NET2}ⁿ is a network parameter of the n-th layer of the target generative network model, and θ_{NET3}ⁿ is a network parameter of the n-th layer of the super-resolution reconstruction model; the value range of the alpha1 is [0,1].

Step S619: creating a super-resolution reconstruction model. In an embodiment, the network structure of the super-resolution reconstruction model is the same as the network structures of the preset convolutional neural network and the generative network, and the network parameters of the super-resolution reconstruction model are fused network parameters.

It can be seen that by applying the method of the embodiments of the present application, the image to be processed can be input into the super-resolution reconstruction model to obtain a target image with a resolution greater than that of the image to be processed. The super-resolution reconstruction model is obtained by performing parameter fusion on the network parameters of the trained preset convolutional neural network and the network parameters of the generative network in the trained generative adversarial network. The super-resolution reconstruction model takes into account the advantages of the convolutional neural network and the generative network in the generative adversarial network, and the obtained target image has a higher definition.

In the embodiments of the present application, the advantage of the target convolutional neural network model is that the generated image is relatively stable, but the disadvantage is that the image lacks partial high-frequency information. The advantage of the trained image generated by the generative network is that the generated image contains more high-frequency information, but the disadvantage is that the image may have artifacts and is not stable enough. The super-resolution reconstruction model performs parameter fusion on the network parameters of the target convolutional neural network model and the generative network in the trained generative adversarial network, and the output target image can contain more high-frequency information and has more image details; and the image is stable, the artifact problem of the image is balanced, and the definition of the target image is high.

As shown in FIG. 7, a schematic structural diagram of an apparatus for image super-resolution according to an embodiment of the present application is shown, which includes:

a to-be-processed image obtaining unit 701 configured for obtaining an image to be processed;

an input unit 702 configured for inputting the image to be processed into a first super-resolution network model and a second super-resolution network model trained in advance, respectively; wherein the first super-resolution network model is a convolutional neural network trained using a plurality of original sample images and corresponding target sample images; the second super-resolution network model is a generative network contained in a generative adversarial network trained using a plurality of original sample images and corresponding target sample images; the network structures of the first super-resolution network model and the second super-resolution network model are the same; the resolutions of the target sample images are greater than the resolutions of the original sample images;

an obtaining unit 703 configured for obtaining a first image output from the first super-resolution network model and a second image output from the second super-resolution network model; wherein the resolution of the first image and the resolution of the second image are both greater than the resolution of the image to be processed;

a target image obtaining unit 704 configured for fusing the first image and the second image to obtain a target image, wherein the resolution of the target image is greater than the resolution of the image to be processed.

In an embodiment, the apparatus further includes: a first super-resolution network model training unit; the first super-resolution network model training unit is specifically configured for: obtaining a training sample set containing a plurality of training samples, wherein each training sample includes an original sample image and a corresponding target sample image; the resolution of the target sample image is greater than the resolution of the original sample image; inputting a first preset number of first original sample images in the training sample set into a current convolutional neural network to obtain first reconstruction target images corresponding to the first original sample images; calculating a loss value based on the first reconstruction target images, first target sample images corresponding to the first original sample images and a preset first loss function; determining whether the current convolutional neural network converges based on the loss value of the preset first loss function; if the current convolutional neural network converges, taking the current convolutional neural network as a trained first super-resolution network model; and if the current convolutional neural network does not converge, adjusting network parameters of the current convolutional neural network, and returning to perform the step of inputting the first preset number of first original sample images in the training sample set into the current convolutional neural network to obtain first reconstruction target images corresponding to the first original sample images.

In an embodiment, the apparatus further includes: a second super-resolution network model training unit; the second super-resolution network model training unit is specifically configured for: taking network parameters of the first super-resolution network model as initial parameters of the generative network in the generative adversarial network to obtain a current generative network; and setting initial parameters of a discrimination network in the generative adversarial network to obtain a current discrimination network; inputting a second preset number of second original sample images in the training sample set into the current generative network to obtain second reconstruction target images corresponding to the second original sample images; and inputting the second reconstruction target images into the current discrimination network to obtain, for each second reconstruction target image, a first current prediction probability value of the second reconstruction target image being a second target sample image; inputting second target sample images corresponding to the second original sample images into the current discrimination network to obtain, for each second target sample image, a second current prediction probability value of the second target sample image being a second target sample image; calculating a loss value based on first current prediction probability values, second current prediction probability values, the real result of whether it is a second target sample image and a preset second loss function; adjusting network parameters of the current discrimination network according to the loss value of the preset second loss function to obtain a current intermediate discrimination network; inputting a third preset number of third original sample images in the training sample set into the current generative network to obtain third reconstruction target images corresponding to the third original sample images; inputting the third reconstruction target images into the current intermediate discrimination network to obtain, for each third reconstruction target image, a third current prediction probability value of the third reconstruction target image being a third target sample image; calculating a loss value based on third current prediction probability values, the real result of whether it is a third target sample image, third target sample images corresponding to the third original sample images, the third reconstruction target images and a preset third loss function; and adjusting the network parameters of the current generative network according to the loss value of the third loss function, and increasing the number of iterations by one, returning to perform the step of inputting the second preset number of second original sample images in the training sample set into the current generative network to obtain second reconstruction target images corresponding to the second original sample images until the preset number of iterations is reached, and taking the trained current generative network as a second super-resolution network model.

In an embodiment, the target image obtaining unit is specifically configured for fusing pixel values of pixels in the first image and pixel values of pixels in the second image according to weights to obtain the target image; wherein the weights are preset or determined based on the resolution of the first image and the resolution of the second image.

In an embodiment, the target image obtaining unit is specifically configured for fusing pixel values of pixels in the first image and pixel values of pixels in the second image according to weights using a following equation to obtain a fused image as a target image:

img3=alpha1*img1+(1−alpha1)*img2

where, alpha1 is the weight of a pixel value for each pixel in the first image respectively, img1 is a pixel value for each pixel in the first image respectively, img2 is a pixel value for each pixel in the second image respectively, and img3 is a pixel value for each pixel in the target image respectively; the value range of alpha1 is [0,1].

It can be seen that by applying the apparatus of the embodiments of the present application, the first image output from the first super-resolution network model and the second image output from the second super-resolution network model can be fused to obtain a target image. The target image takes into account the advantages of the first image output from the first super-resolution network model and the second image output from the second super-resolution network model, and thus has a higher definition.

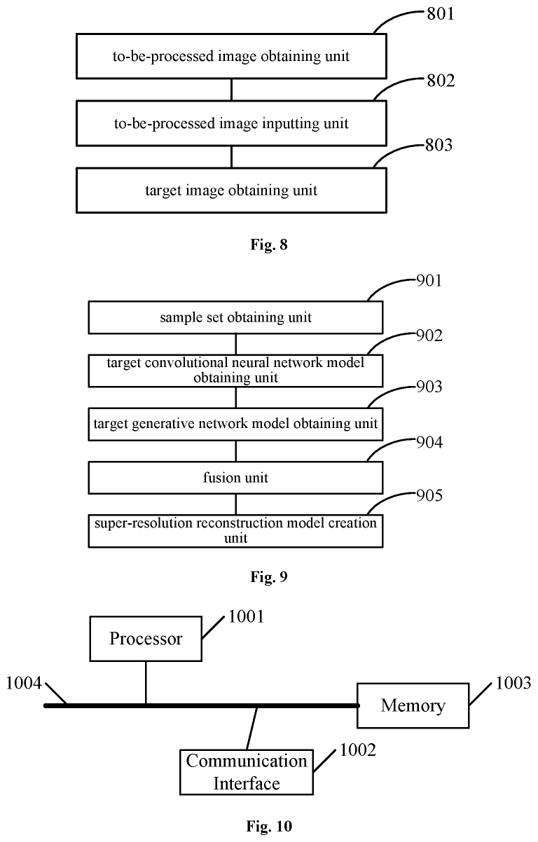

As shown in FIG. 8, a schematic structural diagram of an apparatus for image super-resolution according to another embodiment of the present application includes:

a to-be-processed image obtaining unit 801 configured for obtaining an image to be processed;

a to-be-processed image inputting unit 802 configured for inputting the image to be processed into a pre-trained super-resolution reconstruction model; wherein the super-resolution reconstruction model is obtained by training a preset convolutional neural network and a generative adversarial network comprising a generative network and a discrimination network respectively using a plurality of training samples and then performing parameter fusion on network parameters of the trained preset convolutional neural network and network parameters of the trained generative network; the network structures of the super-resolution reconstruction model, the preset convolutional neural network and the generative network are the same; each training sample comprises an original sample image and a corresponding target sample image, the resolution of the target sample image is greater than the resolution of the original sample image.

a target image obtaining unit 803 configured for obtaining a target image corresponding to the image to be processed output from the super-resolution reconstruction model, and the resolution of the target image is greater than the resolution of the image to be processed.

In an embodiment, the apparatus further includes: a super-resolution reconstruction model training unit; the super-resolution reconstruction model training unit includes:

a sample set obtaining module configured for obtaining a training sample set containing a plurality of training samples, wherein each training sample includes an original sample image and a corresponding target sample image; the resolution of the target sample image is greater than the resolution of the original sample image;

a target convolutional neural network model obtaining module configured for training a preset convolutional neural network based on the training sample set and taking the trained preset convolutional neural network as a target convolutional neural network model;

a target generative network model obtaining module configured for training a generative adversarial network based on the training sample set and taking a generative network in the trained generative adversarial network as a target generative network model;

a fusion module configured for performing weighted fusion on network parameters of each layer of the target convolutional neural network model and network parameters of each layer of the target generative network model respectively to obtain fused network parameters;

a super-resolution reconstruction model creation module configured for creating a super-resolution reconstruction model; wherein the network structure of the super-resolution reconstruction model is the same as the network structures of the preset convolutional neural network and the generative network, and the network parameters of the super-resolution reconstruction model are the fused network parameters.

In an embodiment, the target convolutional neural network model obtaining module is specifically configured for: inputting a first preset number of first original sample images in the training sample set into the current preset convolutional neural network to obtain first reconstruction target images corresponding to the first original sample images; calculating a loss value based on the first reconstruction target images, first target sample images corresponding to the first original sample images and a preset first loss function; determining whether the current preset convolutional neural network converges based on the loss value of the preset first loss function; if the current convolutional neural network converges, obtaining a trained target convolutional neural network model; and if the current convolutional neural network does not converge, adjusting network parameters of the current preset convolutional neural network, and returning to perform the step of inputting the first preset number of first original sample images in the training sample set into the current preset convolutional neural network to obtain first reconstruction target images corresponding to the first original sample images.

In an embodiment, the target generative network model obtaining module is specifically configured for: taking network parameters of the target convolutional neural network model as initial parameters of the generative network in the generative adversarial network to obtain a current generative network; and setting initial parameters of the discrimination network in the generative adversarial network to obtain a current discrimination network; inputting a second preset number of second original sample images in the training sample set into the current generative network to obtain second reconstruction target images corresponding to the second original sample images; inputting the second reconstruction target images into the current discrimination network to obtain, for each second reconstruction target image, a first current prediction probability value of the second reconstruction target image being a second target sample image; and inputting second target sample images corresponding to the second original sample images into the current discrimination network to obtain, for each second target sample image, a second current prediction probability value of the second target sample image being a second target sample image; calculating a loss value based on first current prediction probability values, second current prediction probability values, the real result of whether it is a second target sample image and a preset second loss function; adjusting network parameters of the current discrimination network according to the loss value of the preset second loss function to obtain a current intermediate discrimination network; inputting a third preset number of third original sample images in the training sample set into the current generative network to obtain third reconstruction target images corresponding to the third original sample images; inputting the third reconstruction target images into the current intermediate discrimination network to obtain, for each third reconstruction target image, a third current prediction probability value of the third reconstruction target image being a third target sample image; calculating a loss value based on third current prediction probability values, the real result of whether it is a third target sample image, third target sample images corresponding to the third original sample images, the third reconstruction target images, and a preset third loss function; adjusting the network parameters of the current generative network according to the loss value of the third loss function, increasing the number of iterations by one, and returning to perform the step of inputting the second preset number of second original sample images in the training sample set into the current generative network to obtain second reconstruction target images corresponding to the second original sample images until the preset number of iterations is reached, and taking the trained current generative network as a target generative network model.

In an embodiment, the fusion module is specifically configured for performing weighted fusion on network parameters of each layer of the target convolutional neural network model and network parameters of each layer of the target generative network model according to the following equation to obtain fused network parameters:

θ_{NET3}ⁿ=alpha1*θ_{NET1}ⁿ+(1−alpha1)*θ_{NET2}ⁿ;

where alpha1 is a weight coefficient of a network parameter of the target convolutional neural network model, θ_{NET1}ⁿ is a network parameter of the n-th layer of the target convolutional neural network model, θ_{NET2}ⁿ is a network parameter of the n-th layer of the target generative network model, and θ_{NET3}ⁿ is a network parameter of the n-th layer of the super-resolution reconstruction model; the value range of the alpha1 is [0,1].

It can be seen that by applying the apparatus of the embodiments of the present application, the image to be processed can be input into the super-resolution reconstruction model to obtain a target image with a resolution greater than that of the image to be processed. The super-resolution reconstruction model is obtained by performing parameter fusion on the network parameters of the trained preset convolutional neural network and the network parameters of the generative network in the trained generative adversarial network. The super-resolution reconstruction model takes into account the advantages of the convolutional neural network and the generative network in the generative adversarial network, and the obtained target image has a higher definition.

As shown in FIG. 9, a schematic structural diagram of an apparatus for training a super-resolution reconstruction model according to an embodiment of the present application includes:

a sample set obtaining unit 901 configured for obtaining a training sample set containing a plurality of training samples, wherein each training sample includes an original sample image and a corresponding target sample image; the resolution of the target sample image is greater than the resolution of the original sample image;

a target convolutional neural network model obtaining unit 902 configured for training a preset convolutional neural network based on the training sample set and taking the trained preset convolutional neural network as a target convolutional neural network model;

a target generative network model obtaining unit 903 configured for training a generative adversarial network based on the training sample set and taking a generative network in the trained generative adversarial network as a target generative network model;

a fusion unit 904 configured for performing weighted fusion on network parameters of each layer of the target convolutional neural network model and network parameters of each layer of the target generative network model respectively to obtain fused network parameters;

a super-resolution reconstruction model creation unit 905 configured for creating the super-resolution reconstruction model; wherein the network structure of the super-resolution reconstruction model is the same as the network structures of the preset convolutional neural network and the generative network, and the network parameters of the super-resolution reconstruction model are the fused network parameters.

In an embodiment, the target convolutional neural network model obtaining unit is specifically configured for: inputting a first preset number of first original sample images in the training sample set into the current preset convolutional neural network to obtain first reconstruction target images corresponding to the first original sample images; calculating a loss value based on the first reconstruction target images, first target sample images corresponding to the first original sample images and a preset first loss function; determining whether the current convolutional neural network converges based on the loss value of the preset first loss function; if the current convolutional neural network converges, obtaining a trained target convolutional neural network model; and if the current convolutional neural network does not converge, adjusting network parameters of the current preset convolutional neural network, and returning to perform the step of inputting the first preset number of first original sample images in the training sample set into the current preset convolutional neural network to obtain first reconstruction target images corresponding to the first original sample images.

In an embodiment, the target generative network model obtaining unit is specifically configured for: taking network parameters of the target convolutional neural network model as initial parameters of the generative network in the generative adversarial network to obtain a current generative network; and setting initial parameters of the discrimination network in the generative adversarial network to obtain a current discrimination network; inputting a second preset number of second original sample images in the training sample set into the current generative network to obtain second reconstruction target images corresponding to the second original sample images; inputting the second reconstruction target images into the current discrimination network to obtain, for each second reconstruction target image, a first current prediction probability value of the second reconstruction target image being a second target sample image; and inputting second target sample images corresponding to the second original sample images into the current discrimination network to obtain, for each second target sample image, a second current prediction probability value of the second target sample image being a second target sample image; calculating a loss value based on first current prediction probability values, second current prediction probability values, the real result of whether it is a second target sample image and a preset second loss function; adjusting network parameters of the current discrimination network according to the loss value of the preset second loss function to obtain a current intermediate discrimination network; inputting a third preset number of third original sample images in the training sample set into the current generative network to obtain third reconstruction target images corresponding to the third original sample images; inputting the third reconstruction target images into the current intermediate discrimination network to obtain, for each third reconstruction target image, a third current prediction probability value of the third reconstruction target image being a third target sample image; calculating a loss value based on third current prediction probability values, the real result of whether it is a third target sample image, third target sample images corresponding to the third original sample images, the third reconstruction target images, and a preset third loss function; adjusting the network parameters of the current generative network according to the loss value of the third loss function, increasing the number of iterations by one, returning to perform the step of inputting the second preset number of second original sample images in the training sample set into the current generative network to obtain second reconstruction target images corresponding to the second original sample images until the preset number of iterations is reached, and taking the trained current generative network as a target generative network model.

In an embodiment, the fusion unit is specifically configured for performing weighted fusion on the network parameters of each layer of the target convolutional neural network model and the network parameters of each layer of the target generative network model according to the following equation to obtain fused network parameters:

θ_{NET2}ⁿ=alpha1*θ_{NET1}ⁿ+(1−alpha1)*θ_{NET2}ⁿ;

where alpha1 is a weight coefficient of a network parameter of the target convolutional neural network model, θ_{NET1}ⁿ is a network parameter of the n-th layer of the target convolutional neural network model, θ_{NET2}ⁿ is a network parameter of the n-th layer of the target generative network model, and θ_{NET3}ⁿ is a network parameter of the n-th layer of the super-resolution reconstruction model; the value range of the alpha1 is [0,1].

It can be seen that by applying the apparatus of the embodiments of the present application, the image to be processed can be input into the super-resolution reconstruction model to obtain a target image with a resolution greater than that of the image to be processed. The super-resolution reconstruction model is obtained by performing parameter fusion on the network parameters of the trained preset convolutional neural network and the network parameters of the generative network in the trained generative adversarial network. The super-resolution reconstruction model takes into account the advantages of the convolutional neural network and the generative network in the generative adversarial network, and the obtained target image has a higher definition.

An embodiment of the application also provides an electronic device, as shown in FIG. 10, which includes a processor 1001, a communication interface 1002, a memory 1003 and a communication bus 1004, wherein the processor 1001, the communication interface 1002 and the memory 1003 are communicated with each other through the communication bus 1004.

the memory 1003 is configured to store a computer program;

the processor 1001 is configured to implement the following steps when executing the computer program stored in the memory 1003:

obtaining an image to be processed;

inputting the image to be processed into a first super-resolution network model and a second super-resolution network model trained in advance, respectively; wherein the first super-resolution network model is a convolutional neural network trained using a plurality of original sample images and corresponding target sample images; the second super-resolution network model is a generative network contained in a generative adversarial network trained using a plurality of original sample images and corresponding target sample images; the network structures of the first super-resolution network model and the second super-resolution network model are the same; resolutions of the target sample images are greater than resolutions of the original sample images; obtaining a first image output from the first super-resolution network model and a second image output from the second super-resolution network model; wherein the resolution of the first image and the resolution of the second image are both greater than the resolution of the image to be processed; fusing the first image and the second image to obtain a target image, wherein the resolution of the target image is greater than the resolution of the image to be processed; or

obtaining an image to be processed; inputting the image to be processed into a pre-trained super-resolution reconstruction model; wherein the super-resolution reconstruction model is obtained by training a preset convolutional neural network and a generative adversarial network comprising a generative network and a discrimination network respectively using a plurality of training samples and then performing parameter fusion on network parameters of the trained preset convolutional neural network and network parameters of the trained generative network; the network structures of the super-resolution reconstruction model, the preset convolutional neural network and the generative network are the same; wherein each training sample comprises an original sample image and a corresponding target sample image, the resolution of the target sample image is greater than that of the original sample image; obtaining a target image corresponding to the image to be processed output from the super-resolution reconstruction model, wherein the resolution of the target image is greater than the resolution of the image to be processed; or

obtaining a training sample set containing a plurality of training samples, wherein each training sample includes an original sample image and a corresponding target sample image; the resolution of the target sample image is greater than the resolution of the original sample image; training a preset convolutional neural network based on the training sample set and taking the trained preset convolutional neural network as a target convolutional neural network model; training a generative adversarial network based on the training sample set and taking the generative network in the trained generative adversarial network as a target generative network model; performing weighted fusion on the network parameters of each layer of the target convolutional neural network model and the network parameters of each layer of the target generative network model respectively to obtain fused network parameters; creating a super-resolution reconstruction model; wherein the network structure of the super-resolution reconstruction model is the same as the network structures of the preset convolutional neural network and the generative network, and the network parameters of the super-resolution reconstruction model are the fused network parameters.

It can be seen that by applying the electronic device of the embodiments of the present application, the first image output from the first super-resolution network model and the second image output from the second super-resolution network model can be fused to obtain a target image. The target image takes into account the advantages of the first image output from the first super-resolution network model and the second image output from the second super-resolution network model, and thus has a higher definition. The image to be processed can be input into the super-resolution reconstruction model to obtain a target image with a resolution greater than that of the image to be processed. The super-resolution reconstruction model is obtained by performing parameter fusion on the network parameters of the trained preset convolutional neural network and the network parameters of the generative network in the trained generative adversarial network. The super-resolution reconstruction model takes into account the advantages of the convolutional neural network and the generative network in the generative adversarial network, and the obtained target image has a higher definition.

The communication bus mentioned in the above electronic device may be a Peripheral Component Interconnect (PCI) bus or an Extended Industry Standard Architecture (EISA) bus, etc. The communication bus can be divided into an address bus, a data bus, a control bus etc. For convenience, only one thick line is used in the figures, but it does not mean that there is only one bus or one type of bus. The communication interface is used for communication between the above electronic device and other devices. The memory may include Random Access Memory (RAM), and may also include Non-Volatile Memory (NVM), such as at least one disk memory. In an embodiment, the memory may also be at least one storage located far away from the aforementioned processor.

The above processor may be a general-purpose processor, including a Central Processing Unit (CPU), a Network Processor (NP), etc.; it may also be a Digital Signal Processor (DSP), an Application Specific Integrated Circuit (ASIC), Field-Programmable Gate Array (FPGA) or other programmable logic devices, discrete gates or transistor logic devices, and discrete hardware components.

In yet another embodiment provided in the present application, there is also provided a computer-readable storage medium storing a computer program thereon, wherein the computer program implements any one of the above methods for image super-resolution; or any one of the above methods for training a super-resolution reconstruction model when executed by a processor.

In yet another embodiment provided in the present application, there is also provided a computer program product containing instructions which, when executed by a computer, causes the computer to perform any one of the methods for the image super-resolution in the above embodiments; or any one of the above methods for training a super-resolution reconstruction model.

In the above embodiments, it can be implemented in whole or in part by software, hardware, firmware or any combination thereof. When implemented in software, it may be implemented in whole or in part in the form of a computer program product. The computer program product includes one or more computer instructions. The procedures or functions described in accordance with the embodiments of the application are all or partially generated when the computer program instructions are loaded and executed on a computer. The computer may be a general purpose computer, a special purpose computer, a computer network, or other programmable device. The computer instructions can be stored in a computer-readable storage medium or transmitted from one computer-readable storage medium to another computer-readable storage medium, for example, the computer instructions can be transmitted from one website, computer, server, or data center to another website, computer, server, or data center via wired (e.g., coaxial cable, fiber optic, Digital Subscriber Line (DSL)) or wireless (e.g., infrared, wireless, microwave, etc.). The computer-readable storage medium can be any available medium that can be accessed by a computer or a data storage device, such as a server, a data center, etc., that includes one or more available media. The available medium may be a magnetic medium (e.g., a floppy Disk, a hard Disk, a magnetic tape), an optical medium (e.g., a Digital Versatile Disk (DVD)), or a semiconductor medium (e.g., a Solid State Disk (SSD)), among others.

It is further noted that relational terms herein such as first and second and the like are only used to distinguish one entity or operation from another entity or operation, and do not necessarily require or imply any such actual relationship or order between these entities or operations. Also, the terms “comprise”, “include”, or any other variation thereof, are intended to cover a non-exclusive inclusion, such that a process, method, article, or device that comprises a series of elements includes not only those elements but also other elements not expressly listed or inherent to such process, method, article, or device. Without further limitation, the element defined by the phrase “including a . . . ” does not exclude the presence of other identical elements in the process, method, article, or device including the element.

All the embodiments in the present specification are described in a related way, and the same and similar parts among the embodiments can be referred to each other, and each embodiment focuses on differences from other embodiments.

The above embodiments are only preferred embodiments of the present application, and are not intended to limit the protection scope of the present application. Any modification, equivalent substitution, improvement, etc. made within the spirit and principle of the present application are included in the protection scope of the present application.

### INDUSTRIAL PRACTICABILITY

The method, apparatus, electronic device and medium for image super-resolution and model training provided by the present application can be manufactured or used, and can obtain images with a higher definition and produce positive effects.

1. A method for image super-resolution, comprising:
obtaining an image to be processed;
inputting the image to be processed into a first super-resolution network model and a second super-resolution network model trained in advance, respectively; wherein the first super-resolution network model is a convolutional neural network trained using a plurality of original sample images and corresponding target sample images; the second super-resolution network model is a generative network included in a generative adversarial network trained using a plurality of original sample images and corresponding target sample images; network structures of the first super-resolution network model and the second super-resolution network model are the same; resolutions of the target sample images are greater than resolutions of the original sample images;
obtaining a first image output from the first super-resolution network model and a second image output from the second super-resolution network model;
wherein a resolution of the first image and a resolution of the second image are both greater than a resolution of the image to be processed; and
fusing the first image and the second image to obtain a target image, wherein a resolution of the target image is greater than the resolution of the image to be processed.

2. The method of claim 1, wherein a training process of the first super-resolution network model comprises:
obtaining a training sample set containing a plurality of training samples; wherein each training sample comprises an original sample image and a corresponding target sample image, a resolution of the target sample image is greater than a resolution of the original sample image;
inputting a first preset number of first original sample images in the training sample set into a current convolutional neural network to obtain first reconstruction target images corresponding to the first original sample images;
calculating a loss value based on the first reconstruction target images, first target sample images corresponding to the first original sample images and a preset first loss function; and
determining whether the current convolutional neural network converges based on the loss value of the preset first loss function; if the current convolutional neural network converges, taking the current convolutional neural network as a trained first super-resolution network model; and if the current convolutional neural network does not converge, adjusting network parameters of the current convolutional neural network, and returning to perform a step of inputting the first preset number of first original sample images in the training sample set into the current convolutional neural network to obtain first reconstruction target images corresponding to the first original sample images.

3. The method of claim 2, wherein a training process of the second super-resolution network model comprises:
taking network parameters of the first super-resolution network model as initial parameters of the generative network in the generative adversarial network to obtain a current generative network; and setting initial parameters of a discrimination network in the generative adversarial network to obtain a current discrimination network;
inputting a second preset number of second original sample images in the training sample set into the current generative network to obtain second reconstruction target images corresponding to the second original sample images;
inputting the second reconstruction target images into the current discrimination network to obtain, for each second reconstruction target image, a first current prediction probability value of the second reconstruction target image being a second target sample image; and inputting second target sample images corresponding to the second original sample images into the current discrimination network to obtain, for each second target sample image, a second current prediction probability value of the second target sample image being a second target sample image;
calculating a loss value based on first current prediction probability values, second current prediction probability values, a real result of whether it is a second target sample image and a preset second loss function;
adjusting network parameters of the current discrimination network according to the loss value of the preset second loss function to obtain a current intermediate discrimination network;
inputting a third preset number of third original sample images in the training sample set into the current generative network to obtain third reconstruction target images corresponding to the third original sample images;
inputting the third reconstruction target images into the current intermediate discrimination network to obtain, for each third reconstruction target image, a third current prediction probability value of the third reconstruction target image being a third target sample image;
calculating a loss value based on third current prediction probability values, a real result of whether it is a third target sample image, third target sample images corresponding to the third original sample images, the third reconstruction target images, and a preset third loss function; and
adjusting network parameters of the current generative network according to the loss value of the third loss function, increasing the number of iterations by one, returning to perform a step of inputting the second preset number of second original sample images in the training sample set into the current generative network to obtain second reconstruction target images corresponding to the second original sample images until the preset number of iterations is reached, and taking the trained current generative network as the second super-resolution network model.

4. The method of claim 1, wherein fusing the first image and the second image to obtain a target image comprises:
fusing pixel values of pixels in the first image and pixel values of pixels in the second image according to weights to obtain the target image; wherein the weights are preset or determined based on the resolution of the first image and the resolution of the second image.

5. The method of claim 4, wherein fusing pixel values of pixels in the first image and pixel values of pixels in the second image according to weights to obtain the target image comprises:
fusing pixel values of pixels in the first image and pixel values of pixels in the second image according to weights using a following equation to obtain a fused image as a target image:
img3=alpha1*img1+(1−alpha1)*img2;
wherein, alpha1 is a weight of a pixel value for each pixel in the first image respectively, img1 is the pixel value for each pixel in the first image respectively, img2 is a pixel value for each pixel in the second image respectively, and img3 is a pixel value for each pixel in the target image respectively; a value range of alpha1 is [0,1].

6. A method for image super-resolution, comprising:
obtaining an image to be processed;
inputting the image to be processed into a pre-trained super-resolution reconstruction model; wherein the super-resolution reconstruction model is obtained by training a preset convolutional neural network and a generative adversarial network comprising a generative network and a discrimination network respectively using a plurality of training samples and then performing parameter fusion on network parameters of the trained preset convolutional neural network and network parameters of the trained generative network; network structures of the super-resolution reconstruction model, the preset convolutional neural network and the generative network are the same; wherein each training sample comprises an original sample image and a corresponding target sample image, a resolution of the target sample image is greater than a resolution of the original sample image; and
obtaining a target image corresponding to the image to be processed output from the super-resolution reconstruction model, wherein a resolution of the target image is greater than a resolution of the image to be processed.

7. The method of claim 6, wherein a training process of the super-resolution reconstruction model comprises:
obtaining a training sample set containing a plurality of training samples, wherein each training sample includes an original sample image and a corresponding target sample image, the resolution of the target sample image is greater than the resolution of the original sample image;
training a preset convolutional neural network based on the training sample set, and taking the trained preset convolutional neural network as a target convolutional neural network model;
training the generative adversarial network based on the training sample set, and taking a generative network in the trained generative adversarial network as a target generative network model;
performing weighted fusion on network parameters of each layer of the target convolutional neural network model and network parameters of each layer of the target generative network model respectively to obtain fused network parameters; and
creating the super-resolution reconstruction model; wherein the network structure of the super-resolution reconstruction model is the same as the network structures of the preset convolutional neural network and the generative network, and network parameters of the super-resolution reconstruction model are the fused network parameters.

8. The method of claim 7, wherein training a preset convolutional neural network based on the training sample set and taking the trained preset convolutional neural network as a target convolutional neural network model comprises:
inputting a first preset number of first original sample images in the training sample set into a current preset convolutional neural network to obtain first reconstruction target images corresponding to the first original sample images;
calculating a loss value based on the first reconstruction target images, first target sample images corresponding to the first original sample images and a preset first loss function;
determining whether the current preset convolutional neural network converges based on the loss value of the preset first loss function; if the current convolutional neural network converges, obtaining a trained target convolutional neural network model; and if the current convolutional neural network does not converge, adjusting network parameters of the current preset convolutional neural network, and returning to perform a step of inputting the first preset number of first original sample images in the training sample set into the current preset convolutional neural network to obtain first reconstruction target images corresponding to the first original sample images.

9. The method of claim 8, wherein training the generative adversarial network based on the training sample set and taking a generative network in the trained generative adversarial network as a target generative network model comprises:
taking network parameters of the target convolutional neural network model as initial parameters of the generative network in the generative adversarial network to obtain a current generative network; and setting initial parameters of the discrimination network in the generative adversarial network to obtain a current discrimination network;
inputting a second preset number of second original sample images in the training sample set into the current generative network to obtain second reconstruction target images corresponding to the second original sample images;
inputting the second reconstruction target images into the current discrimination network to obtain, for each second reconstruction target image, a first current prediction probability value of the second reconstruction target image being a second target sample image; and inputting second target sample images corresponding to the second original sample images into the current discrimination network to obtain, for each second target sample image, a second current prediction probability value of the second target sample image being a second target sample image;
calculating a loss value based on first current prediction probability values, second current prediction probability values, a real result of whether it is a second target sample image and a preset second loss function;
adjusting network parameters of the current discrimination network according to the loss value of the preset second loss function to obtain a current intermediate discrimination network;
inputting a third preset number of third original sample images in the training sample set into the current generative network to obtain third reconstruction target images corresponding to the third original sample images;
inputting the third reconstruction target images into the current intermediate discrimination network to obtain, for each third reconstruction target image, a third current prediction probability value of the third reconstruction target image being a third target sample image;
calculating a loss value based on third current prediction probability values, a real result of whether it is a third target sample image, third target sample images corresponding to the third original sample images, the third reconstruction target images, and a preset third loss function; and
adjusting network parameters of the current generative network according to the loss value of the third loss function, increasing the number of iterations by one, returning to perform a step of inputting the second preset number of second original sample images in the training sample set into the current generative network to obtain second reconstruction target images corresponding to the second original sample images until the preset number of iterations is reached, and taking the trained current generative network as the target generative network model.

10. The method of claim 7, wherein performing weighted fusion on network parameters of each layer of the target convolutional neural network model and network parameters of each layer of the target generative network model respectively to obtain fused network parameters comprises:
performing weighted fusion on the network parameters of each layer of the target convolutional neural network model and the network parameters of each layer of the target generative network model according to a following equation to obtain fused network parameters:
θ_{NET3}ⁿ=alpha1*θ_{NET1}ⁿ+(1−alpha1)*θ_{NET2}ⁿ;
wherein, alpha1 is a weight coefficient of a network parameter of the target convolutional neural network model, NET1 represents the target convolutional neural network model, θ_{NET1}ⁿ is a network parameter of a n-th layer of the target convolutional neural network model, NET2 represents the target generative network model, θ_{NET2}ⁿ is a network parameter of a n-th layer of the target generative network model, NET3 represents a super-resolution reconstruction model, and θ_{NET3}ⁿ is a network parameter of a n-th layer of the super-resolution reconstruction model; a value range of the alpha1 is [0,1].

11. A method for training a super-resolution reconstruction model, wherein the method comprises:
obtaining a training sample set containing a plurality of training samples; wherein each training sample comprises an original sample image and a corresponding target sample image, a resolution of the target sample image is greater than a resolution of the original sample image;
training a preset convolutional neural network based on the training sample set and taking the trained preset convolutional neural network as a target convolutional neural network model;
training a generative adversarial network based on the training sample set and taking a generative network in the trained generative adversarial network as a target generative network model;
performing weighted fusion on network parameters of each layer of the target convolutional neural network model and network parameters of each layer of the target generative network model respectively to obtain fused network parameters;
creating the super-resolution reconstruction model; wherein a network structure of the super-resolution reconstruction model is the same as network structures of the preset convolutional neural network and the generative network, and network parameters of the super-resolution reconstruction model are the fused network parameters.

12. The method of claim 11, wherein training a preset convolutional neural network based on the training sample set and taking the trained preset convolutional neural network as a target convolutional neural network model comprises:
inputting a first preset number of first original sample images in the training sample set into a current preset convolutional neural network to obtain first reconstruction target images corresponding to the first original sample images;
calculating a loss value based on the first reconstruction target images, first target sample images corresponding to the first original sample images and a preset first loss function;
determining whether the current convolutional neural network converges based on the loss value of the preset first loss function; if the current convolutional neural network converges, obtaining a trained target convolutional neural network model; and if the current convolutional neural network does not converge, adjusting network parameters of the current preset convolutional neural network, and returning to perform a step of inputting the first preset number of first original sample images in the training sample set into the current preset convolutional neural network to obtain first reconstruction target images corresponding to the first original sample images.

13. The method of claim 12, wherein training the generative adversarial network based on the training sample set and taking a generative network in the trained generative adversarial network as a target generative network comprises:
taking network parameters of the target convolutional neural network model as initial parameters of the generative network in the generative adversarial network to obtain a current generative network; and setting initial parameters of the discrimination network in the generative adversarial network to obtain a current discrimination network;
inputting a second preset number of second original sample images in the training sample set into the current generative network to obtain second reconstruction target images corresponding to the second original sample images;
inputting the second reconstruction target images into the current discrimination network to obtain, for each second reconstruction target image, a first current prediction probability value of the second reconstruction target image being a second target sample image; and inputting second target sample images corresponding to the second original sample images into the current discrimination network to obtain, for each second target sample image, a second current prediction probability value of the second target sample image being a second target sample image;
calculating a loss value based on first current prediction probability values, second current prediction probability values, a real result of whether it is a second target sample image and a preset second loss function;
adjusting network parameters of the current discrimination network according to the loss value of the preset second loss function to obtain a current intermediate discrimination network;
inputting a third preset number of third original sample images in the training sample set into the current generative network to obtain third reconstruction target images corresponding to the third original sample images;
inputting the third reconstruction target images into the current intermediate discrimination network to obtain, for each third reconstruction target image, a third current prediction probability value of the third reconstruction target image being a third target sample image;
calculating a loss value based on third current prediction probability values, a real result of whether it is a third target sample image, third target sample images corresponding to the third original sample images, the third reconstruction target images, and a preset third loss function;
adjusting network parameters of the current generative network according to the loss value of the third loss function, increasing the number of iterations by one, returning to perform a step of inputting the second preset number of second original sample images in the training sample set into the current generative network to obtain second reconstruction target images corresponding to the second original sample images until the preset number of iterations is reached, and taking the trained current generative network as the second super-resolution network model.

14. The method of claim 11, wherein performing weighted fusion on network parameters of each layer of the target convolutional neural network model and network parameters of each layer of the target generative network model respectively to obtain fused network parameters comprises:
performing weighted fusion on the network parameters of each layer of the target convolutional neural network model and the network parameters of each layer of the target generative network model according to a following equation to obtain fused network parameters:
θ_{NET3}ⁿ=alpha1*θ_{NET1}ⁿ+(1−alpha1)*θ_{NET2}ⁿ;
wherein, alpha1 is a weight coefficient of a network parameter of the target convolutional neural network model, NET1 represents the target convolutional neural network model, θ_{NET1}ⁿ is a network parameter of a n-th layer of the target convolutional neural network model, NET2 represents the target generative network model, θ_{NET2}ⁿ is a network parameter of a n-th layer of the target generative network model, NET3 represents a super-resolution reconstruction model, and θ_{NET3}ⁿ is a network parameter of a n-th layer of the super-resolution reconstruction model; a value range of the alpha1 is [0,1].

15.-28. (canceled)

29. An electronic device, comprising a processor, a communication interface, a memory and a communication bus, wherein the processor, the communication interface and the memory are communicated with each other through the communication bus;
the memory is configured to store a computer program;
the processor is configured to implement the method of claim 1 when executing the computer program stored in the memory.

30. A non-transitory computer-readable storage medium storing a computer program thereon, wherein the computer program implements the method of claim 1 when executed by a processor.

31. An electronic device, comprising a processor, a communication interface, a memory and a communication bus, wherein the processor, the communication interface and the memory are communicated with each other through the communication bus;
the memory is configured to store a computer program;
the processor is configured to implement the method of claim 6 when executing the computer program stored in the memory.

32. An electronic device, comprising a processor, a communication interface, a memory and a communication bus, wherein the processor, the communication interface and the memory are communicated with each other through the communication bus;
the memory is configured to store a computer program;
the processor is configured to implement the method of claim 11 when executing the computer program stored in the memory.

33. A non-transitory computer-readable storage medium storing a computer program thereon, wherein the computer program implements the method of claim 6 when executed by a processor.

34. A non-transitory computer-readable storage medium storing a computer program thereon, wherein the computer program implements the method of claim 11 when executed by a processor.
